(19) United States
(12) Patent Application Publication
(10) Pub. No.: US 2009/0319490 A1
(43) Pub. Date: Dec. 24, 2009

(54) Operation control apparatus, method of displaying contents list, and contents display and playback system

(75) Inventors: Shuichi Otsu, Kanagawa (JP); Hideki Sato, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/456,442

(22) Filed: Jun. 17, 2009

(30) Foreign Application Priority Data
Jun. 20, 2008 (JP) P2008-162320
Mar. 24, 2009 (JP) P2009-072342

(51) Int. Cl. G06F 17/30; G06F 15/16

(52) U.S. Cl. 707/3; 709/203; 707/E17.009; 707/104.1

(57) ABSTRACT

An operation control apparatus includes: a display portion; a communication portion that communicates with a contents supply device and a playback device via a network; an operation portion that operates the contents supply device and the playback device via the communication portion; a memory portion that stores therein identification information of contents received from the contents supply device when a playback stop operation is made while the contents are being played back; and a control portion that displays a contents list on the display portion according to contents information received from the contents supply device; wherein the control portion checks identification information of contents contained in the contents information against the identification information of the contents when the contents list is displayed on the display portion and displays a title of contents having a match and a title of contents having no match in different manners.

### BACKGROUND OF THE INVENTION

1. Field of the Invention

The present invention relates to an operation control apparatus, a method of displaying a contents list, and a contents display and playback system. More particularly, the present invention relates to an operation control apparatus that operates a contents supply device and display and playback device via a network.

2. Background Art

It is possible in these days to select and play back contents, such as videos and music, saved in a DMS (Digital Media Server) by a DMP (Digital Media Player) via a home network. It is also possible to select contents by a DMC (Digital Media Controller) to make a DMR (Digital Media Renderer) play back the contents.

In the network as above, when contents, such as videos and music, are played back, the contents, such as videos and music, are not necessarily played back to the end. There are cases where playback is stopped at some midpoint for some reasons and the rest is played back at a later time. Models (for example, 2-box and 3-box models) standardized by DLNA (Digital Living Network Alliance), however, are not standardized to resume the playback of contents stopped in the middle of playback from the stopped position. Such being the case, there has been proposed a contents display and playback system capable of resuming the playback of contents from the stopped position even in a case where the playback is suspended because of the user's convenience (see, for example, JP-A-2007-6443).

### SUMMARY OF THE INVENTION

In the contents display and playback system described above, however, when a considerably large number of contents are saved in the DMS, the user may possibly forget which contents he has viewed to some midpoint. In such a case, it is difficult to find out which contents he has viewed to some midpoint by merely confirming thumbnails, titles, and information about video recording or audio recording dates on the contents selection screen. An HDD (Hard Disk Drive) video recorder shows an icon indicating a newly recorded video in the vicinity of the thumbnail in the contents list for ease of discrimination. This icon, however, is not shown for the contents that have been played back once or more. It is therefore difficult to find out whether the contents of interest have been played back to some midpoint or to the end, that is, whether the contents of interest will be played back from the beginning or from the stopped position when they are played back next by merely viewing the contents list.

In the case of contents saved in a medium, such as a video tape and a cassette tape, it is possible to find out whether they have been played back to some midpoint from a rewind amount of the tape. However, in the case of the contents saved in a medium, such as an HDD and a semiconductor memory, it is difficult to find out whether the contents will be played back from the beginning or from the stopped position unless the contents are playback for the first time. Under these circumstances, there has been a need for a user interface capable of finding out from where the contents will be played back.

There is a recorder incorporating an HDD to video record and accumulate broadcast programs on one hand, and on the other hand, there is a device having a capability of transferring contents to a portable player to provide the user with more chances of viewing the contents that have been video recorded. However, broadcasters limit the transfer for some of the video recorded contents because of the copyright authorization, and the recorder may disable the playback of some contents moved out to a portable player by transfer. A data volume may be reduced at the time of transfer by transcoding or translating the contents because the storage and playback resources of the portable player are generally not as rich as those in the recorder. For such a case, there is a capability of enabling the playback of the originally video recorded contents by returning the contents moved out to a portable player by transfer back to the recorder.

Meanwhile, according to DLNA that realizes a home network, the capability of downloading contents from the DMS and the capability of uploading contents to the DMS conversely are standardized, and the environment to further assist the capability of sharing the contents saved on the DMS has been improved. Under the existing circumstances, however, contents moved out to a portable player and contents shared over the home network are independent because of a difference of the save formats. Accordingly, in a case where the user wishes to resume the playback of contents that have been played back to some midpoint by a portable device from the stopped position by a home AV device constituting the home network, the user has to make operations as follows. That is, after the user specifies the contents on the home network, he specifies the position from which he wishes to resume the playback or the user starts the playback after he has located the start position using the fast-forwarding capability. This consequently makes an operation to play back the rest of the contents from the stopped position quite bothersome. For instance, when the user enjoying the contents played back, for example, by a portable player, comes back home, he may rather wish to play back the rest of the contents by the home AV device constituting the home network. Nevertheless, he resumes the playback by the portable player to avoid a bothersome operation.

It is therefore desirable to provide an operation control apparatus, a method of displaying a contents list, and a contents display and playback system that make it easy to discriminate between contents that will be played back from the beginning and contents that will be played back from the stopped position when contents are played back.

It is also desirable to provide an operation control apparatus, a method of displaying a contents list, and a contents display and playback system that enable devices to seamlessly play back contents that have been played back to some midpoint by another device.

According to an embodiment of the present invention, there is provided an operation control apparatus that includes: a display portion that displays information thereon; a communication device that communicates with a contents supply device and a playback device via a network; an operation portion that operates the contents supply device and the playback device via the communication portion; a memory portion that stores therein, when a playback stop operation is made by the operation portion while contents received from the contents supply device are being played back, playback position information of the contents when playback was stopped and identification information of the contents in correlation with each other; and a control portion that displays a contents list on the display portion according to contents information received from the contents supply device. The control portion checks identification information of contents contained in the contents information received from the contents supply device against the identification information of the contents stored in the memory portion when the contents list is displayed on the display portion and displays a title of contents having a match and a title of contents having no match in different manners.

According to another embodiment of the present invention, there is provided a method of displaying a contents list that includes the steps of storing, when a playback stop operation is made by an operation portion while contents received from a contents supply device via a network are being played back, playback position information of the contents when playback was stopped and identification information of the contents in a memory portion in correlation with each other, and checking identification information of contents contained in contents information received from the contents supply device against the identification information of the contents stored in the memory portion and displaying a title of contents having a match and a title of contents having no match in different manners.

According to still another embodiment of the present invention, there is provided a contents display and playback system that includes: a contents supply device that accumulates contents therein; a playback device that plays back contents received from the contents supply device via a network; and an operation control apparatus that operates the contents supply device and the playback device via the network. The operation control apparatus includes: a display portion that displays information thereon; a communication portion that communicates with the contents supply device and the playback device via the network; an operation portion that operates the contents supply device and the playback device via the communication portion; a memory portion that stores therein, when a playback stop operation is made by the operation portion while the contents received from the contents supply device are being played back, playback position information of the contents when playback was stopped and identification information of the contents in correlation with each other; a control portion that displays a contents list on the display portion according to the contents information received from the contents supply device. The control portion checks identification information of contents contained in the contents information received from the contents supply device against the identification information of the contents stored in the memory portion when the contents list is displayed on the display portion, and displays a title of contents having a match and a title of contents having no match in different manners.

According to the embodiments of the present invention, when the contents list is displayed on the display portion, the identification information of the contents contained in the contents information is checked against the identification information of the contents stored in the memory portion. The title of the contents having a match and the title of the contents having no match are displayed in different manners. The user is therefore able to find out which contents have been played back to some midpoint easily by merely viewing the contents list.

Also, in a case where a playback operation is made by the operation control portion, the display control portion reads out the identification information of the contents selected by the playback operation and the playback position information of the contents correlated with the identification information from the memory portion. The operation control portion then makes the playback device play back the contents from the position corresponding to the playback position information of the contents according to the identification information of the contents and the playback position information of the contents. It thus becomes possible to play back the contents that have been played back to some midpoint by the operation control apparatus seamlessly by the playback device.

As has been described, according to the embodiments of the present invention, in a case where contents are played back, contents that will be played back from the beginning and contents that will be played back from the stopped position can be readily discriminated from the contents list.

### BRIEF DESCRIPTION OF THE DRAWINGS

FIG. 1 is a view schematically showing a first example of the configuration of a contents display and playback system according to an embodiment of the present invention;

FIG. 2 is a view schematically showing a second example of the configuration of the contents display and playback system according to an embodiment of the present invention;

FIG. 3 is a view schematically showing a third example of the configuration of the contents display and playback system according to an embodiment of the present invention;

FIG. 4 is a functional block diagram showing an example of the configuration of a contents supply portion;

FIG. 5 is a block diagram showing an example of the hardware configuration of the contents supply portion;

FIG. 6 is a functional block diagram showing an example of the configuration of a display and playback portion;

FIG. 7 is a block diagram showing an example of the hardware configuration of the display and playback portion;

FIG. 8 is a functional block diagram showing an example of the configuration of an operation control portion;

FIG. 9 is a block diagram showing an example of the hardware configuration of the operation control portion;

FIG. 10 is a view showing an example of the software configuration of the operation control portion;

FIG. 11 is a schematic diagram showing an example of the display of a contents list;

FIG. 12 is a schematic diagram showing an example of a playback resume information database;

FIG. 13 is a schematic diagram showing another example of the playback resume information database;

FIG. 14 is a flowchart depicting an example of GUI display and the processing during the playback using the playback resume information;

FIG. 15 is a flowchart depicting an example of the processing to perform playback stop operation control while contents are being played back to store the playback resume information of the contents;

FIG. 16 is a flowchart depicting an example of operations when contents are downloaded from the contents supply portion into the operation control portion;

FIG. 17 is a flowchart depicting an example of operations when contents that have been played back to some midpoint by the operation control portion are played back seamlessly by the display and playback portion; and

FIG. 18 is a flowchart depicting an example of operations when contents that have been played back to some midpoint by the operation control portion are played back seamlessly by the display and playback portion.

### DESCRIPTION OF THE PREFERRED EMBODIMENTS

Embodiments of the present invention will be described in the following order:

(1) First embodiment (example of contents display and playback system); and

(2) Second embodiment (example where a contents supply portion has a DMR capability).

### (1) First Embodiment

### Configuration of Contents Display and Playback System

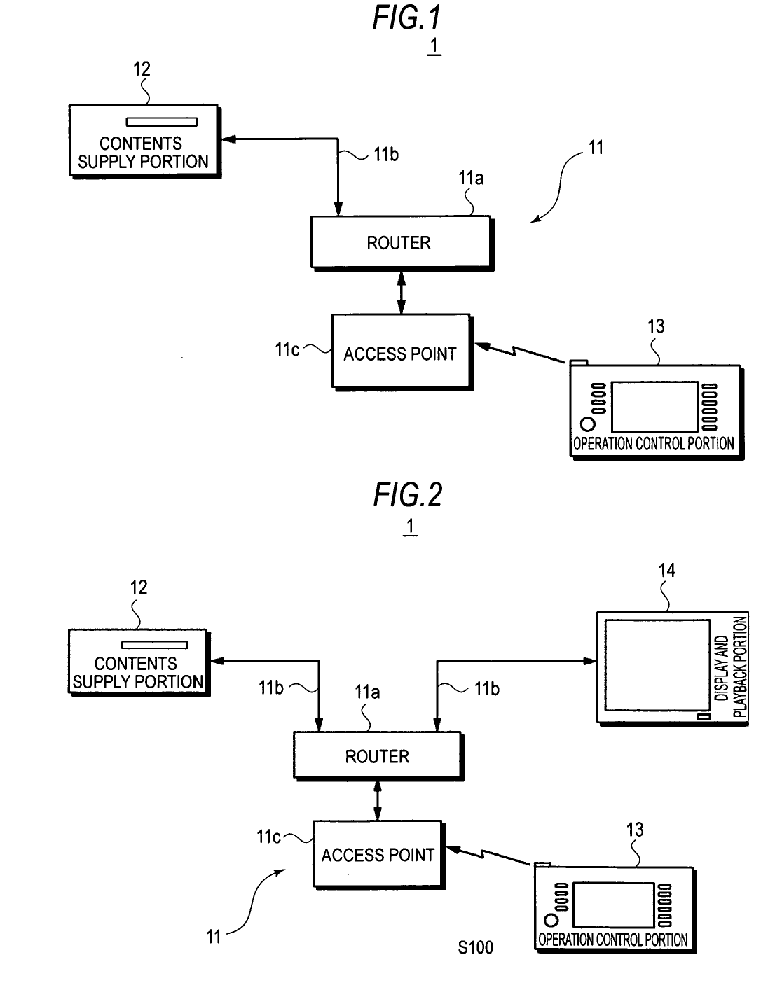

FIG. 1 is a view schematically showing a first example of the configuration of a contents display and playback system according to an embodiment of the present invention. As is shown in FIG. 1, a contents display and playback system 1 includes a single contents supply portion 12, a concrete example of which is an AV contents server represented by a digital video recorder, and an operation control portion 13 that controls operations of the contents supply portion 12. The contents supply portion 12 and the operation control portion 13 are linked to a home network 11 constructed by combining a wireless network and a cable network.

The home network 11 is a home digital network. In the home network 11, the contents supply portion 12 is linked to a router 11a, for example, via a LAN cable 11b. Also, a wireless LAN access point 11c is linked to the router 11a. The operation control portion 13 is wirelessly linked to the access point 11c using a predetermined protocol, for example, IEEE802.11 protocol or a protocol developed on top of IEEE802.11 specifications. The operation control portion 13 is therefore linked to the contents supply portion 12 on the home network 11 and is thereby able to control operations of the linked portion.

FIG. 2 is a view schematically showing a second example of the configuration of the contents display and playback system according to an embodiment of the present invention. In this contents display and playback system 1, as is shown in FIG. 2, a single display and playback portion 14 is linked to a router 11a. The operation control portion 13 is therefore linked to both the contents supply portion 12 and the display and playback portion 14 on the home network 11 and is thereby able to control operations of the linked portions.

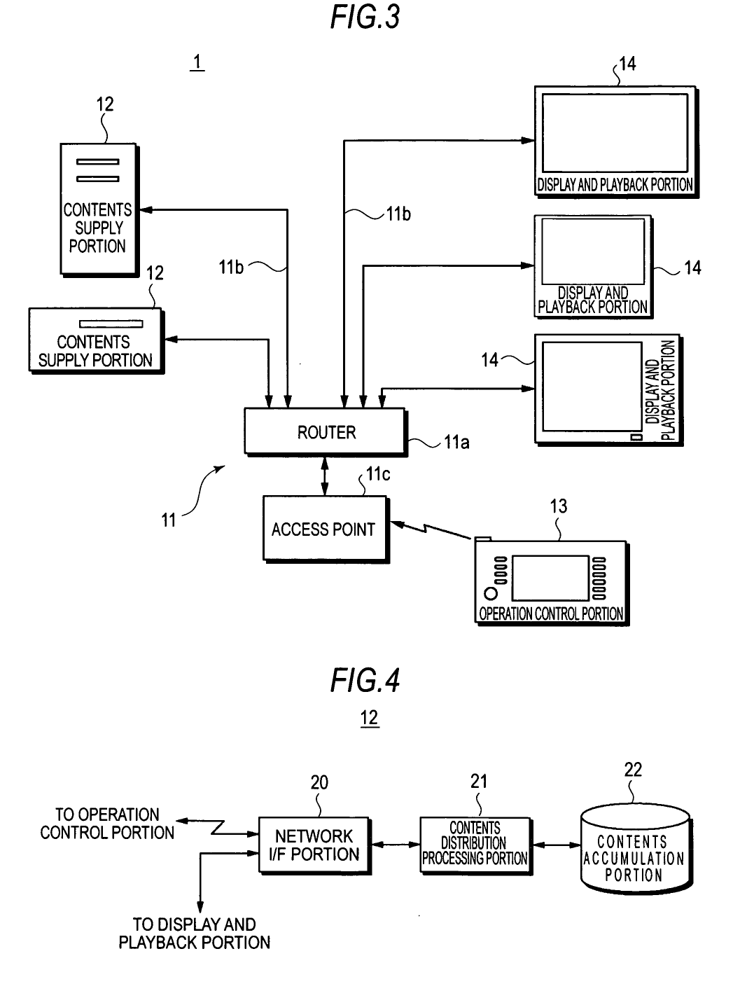

FIG. 3 is a view schematically showing a third example of the configuration of the contents display and playback system according to an embodiment of the present invention. In this contents display and playback portion 1, as is shown in FIG. 3, two contents supply portions 12 and three display and playback portions 14 are linked to the router 11a. The operation control portion 13 is therefore linked to the two contents supply portions 12 and the three display and playback portions 14 and is thereby able to control operations of the linked portions.

Hereinafter, the contents display and playback system 1 shown in FIG. 2 will be described as an embodiment of the present invention. It should be appreciated, however, that the present invention is not limited to the system of this example and the present invention is also applicable to the contents display and playback systems 1 shown in FIG. 1 and FIG. 3.

The contents supply portion 12 serving as a DMS is an AV (Audio Visual) contents server capable of supplying AV contents by streaming distribution. AV contents are stored in the contents supply portion 12.

The display and playback portion 14, which is a client, has a streaming playback capability of receiving the contents supplied by streaming distribution from the contents supply portion 12 and playing back the contents so that videos are displayed thereon or sounds are outputted therefrom. The display and playback portion 14 is under the control of the operation control portion 13.

The operation control portion 13, which is a client, is a remote controller to operate the contents supply portion 12 and the display and playback portion 14 both linked to the home network 11 under its control. The operation control portion 13 has an output device, for example, an LCD (Liquid Crystal Display) or a speaker, and has a capability of performing streaming playback of the AV contents supplied by streaming distribution from the contents supply portion 12. The operation control portion 13 also has a CP (Control Point) for controlling the respective devices linked to the home network 11. In short, the operation control portion 13 has the capability of performing streaming playback of AV contents and the capability of controlling the contents supply portion 12 and the display and playback portion 14 linked to the network 11.

The operation control portion 13 controls transmission and reception of contents among the respective portions including the operation control portion 13 itself, and controls a display of videos and playback of sounds by the display and playback portion 14 and the operation control portion 13 itself. The operation control portion 13 is allowed to access devices on the home network 11 by way of the wireless LAN access point 11c using the wireless LAN portion of the home network 11. The operation control portion 13 transmits a streaming distribution request to the contents supply portion 12 and is capable of setting client operations when streaming playback is performed.

When AV contents present in the contents supply portion 12 serving as a DMS are displayed or played back by the display and playback portion 14 or the operation control portion 13, the operation control 13 sets a playback start position as the user desires. When the user makes a playback stop operation using the operation control portion 13 while the contents received from the contents supply portion 12 are being played back by the display and playback portion 14 or the operation control portion 13, the operation control portion 13 performs the processing as follows. That is, the operation control portion 13 acquires playback position information (playback resume information) of the contents when the playback was stopped from the display and playback portion 14 or the like and stores this information therein.

When the operation control portion 13 stores the playback resume information, it stores identification information that uniquely identifies the contents of interest within the home network 11. For example, it stores identification information (for example, Object ID in CDS of UPnP) that identifies all the contents held in the contents supply portion 12 individually and identification information (for example, UDN in Device Architecture of UPnP) that identifies the contents supply portion 12, which is the supply source of the contents, in correlation with each other. In a case where the contents display and playback system 1 has more than one contents supply portion 12 as is shown in FIG. 3, the contents may not be identified uniquely within the home network 11 with the identification information identifying the contents alone. It is therefore preferable to combine the identification information identifying the contents with the identification information identifying each contents supply portion 12.

Meanwhile, even when the playback resume information is stored in the operation control portion 13, it is necessary to reflect this information on the GUI (Graphical User Interface) of the playback operation control by the operation control portion 13. Unless this information is reflected, the user has no idea whether the contents of interest will be played back from the beginning or from the stopped position until the playback is actually started by the display and playback portion 14 or the operation control portion 13. The user has no clue to select contents he has viewed to some midpoint, either. Hence, according to an embodiment of the present invention, the operation control portion 13 performs the GUI expression to enable the user to select contents as follows. That is, an icon as a mark indicating that the contents of interest have been played back to some midpoint is displayed in the vicinity of the title of the contents having the playback resume information (hereinafter, referred to as the icon indicating the presence of the playback resume information). In short, the contents for which the playback resume information is present in the operation control portion 13 and the contents for which the playback resume information is absent in the operation control portion 13 are displayed in different manners.

When the user selects the contents for which the playback resume information is present in the operation control portion 13 and controls a playback operation, the operation control portion 13 performs the processing as follows. That is, it requests to resume the playback of the contents from the stopped position by the display and playback portion 14 or the operation control portion 13 itself according to the playback resume information, so that the contents are played back from the stopped position. The user already knows that the contents will be played back from the stopped position when he started the playback control and the user therefore understands that the operation result by the playback operation control is normal. Because the icon indicating the presence of the playback resume information indicates that the playback resume information (playback history) is present in the operation control portion 13, it can be a clue when the user selects contents he has viewed to some midpoint.

The configurations of the contents supply portion 12, the display and playback portion 14, and the operation control portion 13 as above will now be described.

### Contents Supply Portion

FIG. 4 is a functional block diagram showing an example of the configuration of the contents supply portion 12. As is shown in FIG. 4, the contents supply portion 12 includes a network interface portion (hereinafter, denoted as the I/F portion) 20, a contents distribution processing portion 21, and a contents accumulation portion 22.

The contents accumulation portion 22 is a large-capacity storage medium, such as a hard disk. For example, the contents accumulation portion 22 accumulates contents obtained via broadcast waves and the Internet and from recoding media, such as a DVD (Digital Versatile Disc) and a CD (Compact Disc) as streaming data.

The network I/F portion 20 is an interface functional portion that links the contents accumulation portion 22 to the home network 11. The contents distribution processing portion 21 receives a distribution request transmitted from the operation control portion 13 via the network I/F portion 20. The contents data accumulated in the contents accumulation portion 22 are read out in response to this request and the read contents data are transmitted to the request sender display and playback portion 14 or operation control portion 13 via the network I/F portion 20 by streaming distribution.

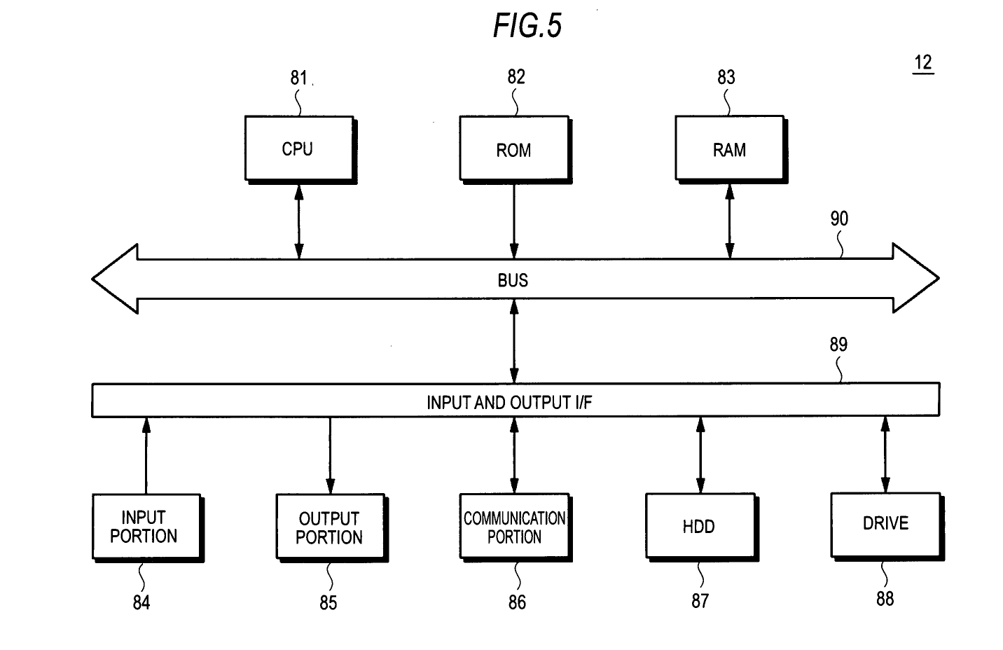

FIG. 5 is a block diagram showing an example of the hardware configuration of the contents supply portion 12. As is shown in FIG. 5, the contents supply portion 12 includes a CPU (Central Processing Unit) 81, a ROM (Read Only Memory) 82, and a RAM (Random Access Memory) 83. In addition, the contents supply portion 12 includes an input portion 84, an output portion 85, a communication portion 86, an HDD 87, a drive 88, and an input and output I/F 89. The CPU 81 is connected to the ROM 82, the RAM 83, and the input and output I/F 89 via a bus 90. The input portion 84, the output portion 85, the communication portion 86, the HDD 87, and the drive 88 are connected to the input and output I/F 89.

The CPU 81 controls the respective portions provided to the contents supply portion 12. The ROM 82 pre-records various processing programs as well as data necessary for the processing. The RAM 83 is chiefly used as a work area for various types of processing and temporarily stores and holds data obtained as the result of various types of processing. The input portion 84 accepts an operation input made by the user and supplies an operation signal corresponding to the operation input made by the user to the CPU 81. The output portion 85 includes a display device, such as an LCD and a CRT (Cathode-Ray Tube), and displays various types of information under the control of the CPU 81. When the necessity arises, the output portion 85 may include an audio output portion, such as a speaker, so that various sounds are outputted from the audio output portion.

The communication portion 86 makes communications with the router 11a via the LAN cable 11b according to a predetermined protocol. The communication portion 86 transmits contents by streaming distribution, for example, via the LAN cable 11b. The HDD 87 accumulates therein the contents obtained via broadcast waves and the Internet and from recording media, such as a BD (Blu-ray Disc), a DVD, and a CD, as the streaming data. The drive 88 is capable of recording data into and playing back data from various recoding media. For example, data played back by the drive 88 is accumulated in the HDD 87.

### Display and Playback Portion

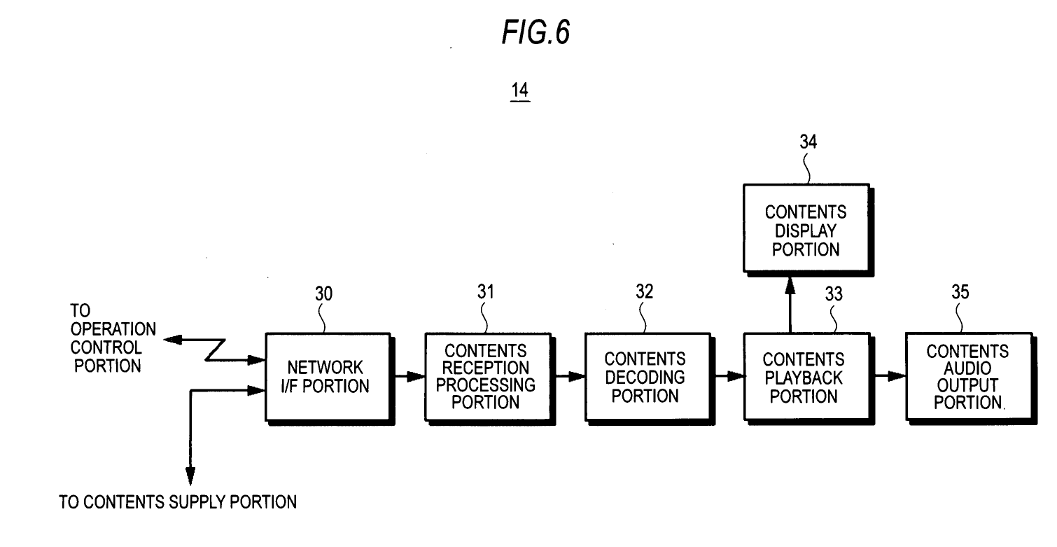

FIG. 6 is a functional block diagram showing an example of the configuration of the display and playback portion 14. As is shown in FIG. 6, the display and playback portion 14 includes a network I/F portion 30, a contents reception processing portion 31, a contents decoding portion 32, a contents playback portion 33, a contents display portion 34, and a contents audio output portion 35.

The network I/F portion 30 is an interface functional portion that links the display and playback portion 14 to the home network 11. The contents reception processing portion 31 receives contents data transmitted by streaming distribution via the network I/F portion 30 and supplies the received contents data to the contents decoding portion 32. The contents decoding portion 32 decodes the contents data supplied from the contents reception processing portion 31 and supplies the decoded contents data to the contents playback portion 33.

The contents playback portion 33 plays back the contents data supplied from the contents decoding portion 32 and isolates the contents data, for example, to video data and audio data. It then supplies the isolated video data to the contents display portion 34 and supplies the isolated audio data to the contents audio output portion 35. The contents display portion 34 includes a display device, such as an LCD and a CRT, and displays thereon videos according to the video data played back by the contents playback portion 33. The contents audio output portion 35 includes a speaker or the like and outputs sounds according to the audio data supplied from the contents playback portion 33.

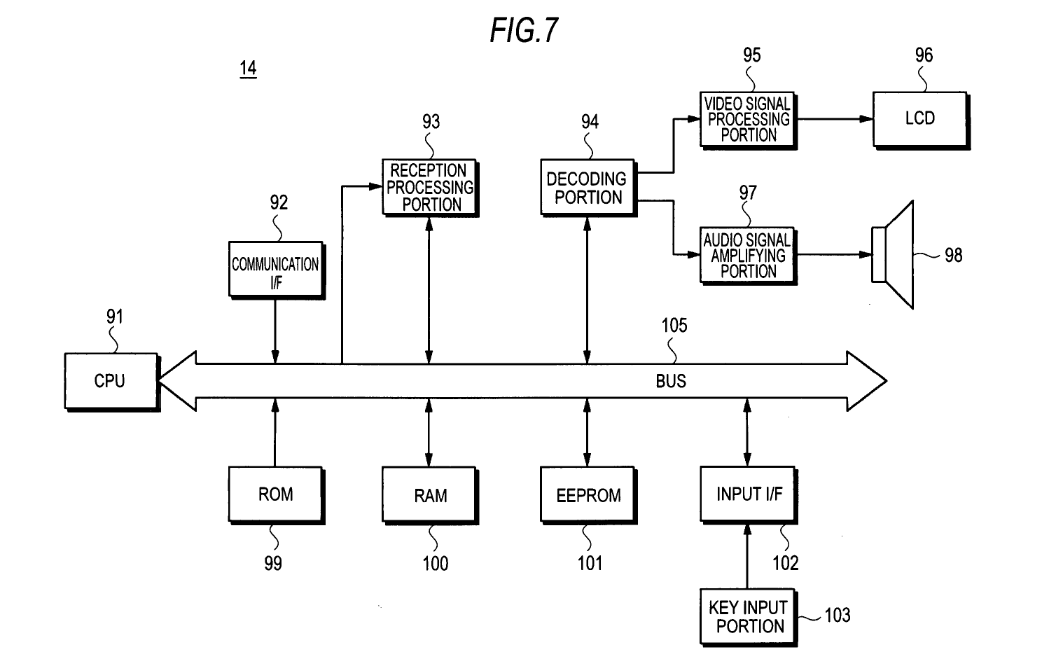

FIG. 7 is a block diagram showing an example of the hardware configuration of the display and playback portion 14. As is shown in FIG. 7, the display and playback portion 14 includes a CPU 91, a communication portion 92, a reception processing portion 93, a decoding portion 94, a video signal processing portion 95, an LCD 96, an audio signal amplifying portion 97, and a speaker 98. The CPU 91 is connected to the communication portion 92, the reception processing portion 93, and the decoding portion 94 via a bus 105. The video signal processing portion 95 and the audio signal amplifying portion 97 are connected to the decoding portion 94. The LCD 96 is connected to the video signal processing portion 95 and the speaker 98 is connected to the audio signal amplifying portion 97.

Also, as is shown in FIG. 7, the display and playback portion 14 includes a ROM 91, a RAM 100, an EEPROM (Electrical Erasable Programmable ROM) 101, an input I/F portion 102, and a key input portion 103. The CPU 91 is connected to the ROM 99, the RAM 100, the EEPROM 101, and the input I/F portion 102 via the bus 105. The key input portion 103 is connected to the input I/F portion 102.

The CPU 91 controls the respective portions provided to the display and playback portion 14. The communication portion 92 makes communications with the router 11a via the LAN cable 11b according to a predetermined protocol. The communication portion 92 receives the contents transmitted from the contents supply portion 12 by streaming distribution, for example, via the LAN cable 11b. The reception processing portion 93 applies predetermined signal processing on the contents data supplied from the communication portion 92 and supplies the processed contents data to the decoding portion 94.

The decoding portion 94 decodes the contents data and supplies the decoded video data to the video signal processing portion 95 whereas it supplies the decoded audio data to the audio signal amplifying portion 97. The video signal processing portion 95 then applies predetermined signal processing on the video data supplied from the decoding portion 94 and supplies the processed video data to the LCD 96. The LCD 96 displays thereon an image according to the video data supplied from the video signal processing portion 95. The audio signal amplifying portion 97 applies amplification processing on the audio signal supplied from the decoding signal 94 and supplies the processed audio signal to the speaker 98. The speaker 98 outputs sounds according to the audio signal supplied from the audio signal amplifying portion 97.

The ROM 99 pre-records various processing programs as well as data necessary for the processing. The RAM 100 is chiefly used as a work area for various types of processing and temporarily stores and holds data obtained as the result of various types of processing. The EEPROM 101 stores various types of data for the settings of the display and playback control 14. The input I/F portion 102 is used for reception and transmission of signals between the CPU 91 and the key input portion 103. The key input portion 103 accepts an operation input made by the user and supplies an operation signal corresponding to the operation input made by the user to the CPU 91 via the input I/F portion 102.

### Operation Control Portion

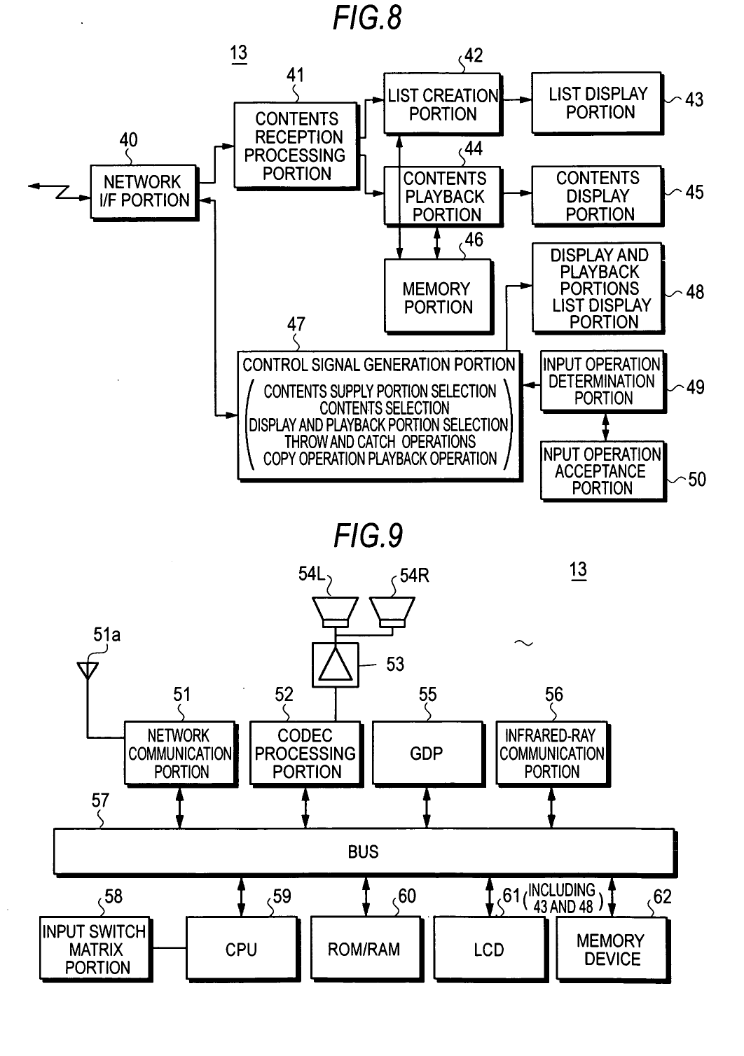

FIG. 8 is a functional block diagram showing an example of the configuration of the operation control portion 13. The operation control portion 13 includes a network I/F portion 40, a contents reception processing portion 41, a list creation portion 42, a list display portion 43, a contents playback portion 44, a contents display portion 45, and a memory portion 46. Also, the operation control portion 13 includes a control signal generation portion 47, a display and playback portions list display potion 48, an input operation determination portion 49, and an input operation acceptance portion 50.

The network I/F portion 40 is an interface functional portion that links the operation control portion 13 to the home network 11. To be more concrete, the network I/F portion 40 is an interface functional portion that makes wireless communications with the wireless LAN access point 11c of the home network 11 according to a predetermined protocol. For example, it is an interface functional portion that makes wireless communications according to a predetermined protocol, such as IEEE802.11 protocol or a protocol developed on top of IEEE802.11 specifications.

The contents reception processing portion 41 receives contents information about the contents and the contents data itself from the contents supply portion 12 via the network I/F portion 40 and applies processing, such as decoding, on the received contents information and contents data. It then supplies the processed contents information about the contents to the list creation portion 42 and the processed contents data itself to the contents playback portion 44. The contents information contains identification information of the contents supply portion 12, titles of the contents accumulated in the contents supply portion 12, and identification information of the contents.

The list creation portion 42 creates a contents list on the basis of the contents information about the contents supplied from the contents reception processing portion 41 and supplies the contents list to the list display portion 43. The list display portion 43 displays thereon the contents list supplied from the list creation portion 42. In this instance, the list creation portion 42 checks the identification information of the contents contained in the contents information against the identification information of the contents stored in the memory portion 46 and displays the contents having a match and the contents having no match in different manners on the list display portion 43. For example, for the contents having a match, the icon indicating the presence of the playback resume information is displayed in the vicinity of the contents title.

The contents playback portion 44 applies processing, such as decoding, on the contents data supplied from the contents reception processing portion 41 and performs streaming playback of the contents data in the contents display portion 45. The contents display portion 45 includes a display device, such as an LCD, and displays videos thereon according to the contents data supplied from the contents playback portion 44. The memory portion 46 stores therein contents data supplied from the contents playback portion 44 and the playback resume information. To be more concrete, the memory portion 46 has a playback resume information database and the playback resume information is registered in the playback resume information database. The playback resume information database is, for example, a relational database and has following items: identification information of the contents supply portions as the supply source of the contents, identification information of the contents, and time information of the contents when the playback was stopped.

The input operation acceptance portion 50 accepts an operation input made by the user and supplies an operation signal corresponding to the operation input made by the user to the input operation determination portion 49. The input operation determination portion 49 determines what type of input operation is accepted at the input operation acceptance portion 50 as the input operation made by the user. To be more concrete, it makes a determination in response to a key input operation made by the user by depressing, rotating, pushing up, or pushing down operation tools provided to the input operation acceptance portion 50.

The control signal generation portion 47 has a capability of generating an operation signal to enable transmission and reception of video information among the respective portions in response to an operation input at the input operation acceptance portion 50. The control signal generation portion 47 generates various control signals on the basis of the determination result by the input operation determination portion 49. Concrete examples of the controls signals generated as above include but not limited to a contents supply portion selection signal, a contents selection signal, a display and playback portion selection signal, throw and catch operation signals, a copy operation signal, and a playback operation signal.

The contents supply selection signal is an operation signal to select a desired contents supply portion 12 according to an input operation made by the user in a case where more than one contents supply portion 12 is linked to the home network 11 as is shown in FIG. 3.

The contents selection signal is an operation signal to select desired contents. The contents selection signal is generated in response to an operation made by the user who has visually confirmed the contents list created by the list creation portion 42 on the basis of information about the contents received at the contents reception processing portion 41 and displayed on the list display portion 43.

The display and playback portion selection signal is an operation signal to select a desired display and playback portion 14 in a case where more than one display and playback portion 14 is linked to the home network 11. The display and playback portion selection signal is generated in response to an operation made by the user who has visually confirmed the display and control portions list displayed on the display and playback portions list display portion 48.

The throw operation signal is an operation signal to make a desired display and playback portion 14 perform streaming playback of the contents data stored in a desired contents supply portion 12. The catch operation signal is an operation signal to display contents data being displayed by the display and playback portion 14 on the contents display portion 45 of the operation control portion 13.

The copy operation signal is an operation signal to copy the contents. The playback operation signal is an operation signal to play back contents and to stop and pause the playback by the contents display portion 45 of the operation control portion 13 itself. Besides these signals, there are operation signals to start, stop, and pause the playback of the contents by the display and playback portion 14 selected from the display to play back the contents.

In a case where the user makes a playback stop operation using the input operation acceptance portion 50 while the contents received from the contents supply portion 12 are being played back by the display and playback portion 14, the control signal general portion 47 performs the processing as follows. That is, it sends a signal requesting the time information of the contents when the playback was stopped to the display and playback portion 14 via the network I/F portion 40. In response to this signal, the contents reception processing portion 41 receives the time information of the contents when the playback was stopped from the display and playback portion 14. The list creation portion 42 stores in the memory portion 46 the time information of the contents when the playback was stopped, which is received at the contents reception portion 41. To be more concrete, it stores the time information of the contents when the playback was stopped, the identification information of the contents, and the identification information of the contents supply portion 12 as the supply source of the contents in the memory portion 46 by correlating one with another.

In a case where the user makes a playback stop operation using the input operation acceptance portion 50 while the contents received from the contents supply portion 12 are being played back by the operation-control portion 13, it stores the time information of the contents when the playback by the contents playback portion 44 was stopped in the memory portion 46.

FIG. 9 is a block diagram showing an example of the hardware configuration of the operation control portion 13. As is shown in FIG. 9, the operation control portion 13 includes an antenna 51a, a network communication portion 51, a codec processing portion 52, an amplifier 53, speakers 54L and 54R, a GDP (Graphics Display Processor) 55, and an infrared-ray communication portion 56. Also, the operation control portion 13 includes a bus 57, an input switch matrix portion 58, a CPU 59, a ROM/RAM 60, an LCD 61, and a memory device 62.

The CPU 59 is connected to the network communication portion 51, the codec processing portion 52, the GDP 55, and the infrared-ray communication portion 56 via the bus 57. Also, the CPU 59 is connected to the ROM/RAM 60, the LCD 61, and the memory device 62 via the bus 57. Also, the input switch matrix portion 58, which is the input operation acceptance portion 50, is connected to the CPU 59.

The network communication portion 51 makes wireless communications with the wireless LAN access point 11c via the antenna 51a according to a predetermined protocol, such as IEEE802.11 protocol or a protocol developed on top of the IEEE802.11 specifications. The network communication portion 51 receives the contents transmitted by streaming distribution, for example, via the antenna 51a.

The codec processing portion 52 isolates the contents received at the network communication portion 51 to video data and audio data under the control of the CPU 59 and decodes the isolated video data and audio data. The amplifier 53 amplifies the audio data decoded by the codec processing portion 52 and supplies the amplified audio data to the stereo 2-channel speakers 54L and 54R. The stereo 2-channel speakers 54L and 54R make sounds according to the audio data supplied from the amplifier 53. The GDP 55 applies predetermined video signal processing on the video data decoded by the codec processing portion 52. The infrared-ray communication portion 56 transmits an operation signal in the form of an infrared ray to directly remote-control various electronic devices to a control signal reception portion in an electric device that is to be controlled.

The CPU 59 controls the respective portions provided to the operation control portion 13. The CPU 59 functions as the control signal generation portion 47 in response to a user input operation on the input switch matrix portion 58, which is the input operation portion, and thereby generates various control signals. It then transmits the various control signals thus generated to the contents supply portion 12 or the display and playback portion 14 via the access point 11c. It also receives a response signal responding to this transmission signal from the contents supply portion 12 or the display and playback portion 14.

In a case where the user makes a playback stop operation using the input switch matrix portion 58 while the contents received from the contents supply portion 12 are being played back by the display and playback portion 14, the CPU 59 performs the processing as follows. That is, it transmits a signal requesting the time information of the contents when the playback was stopped to the display and playback portion 14 via the network I/F portion 40. In response to this signal, the CPU 59 receives the time information of the contents when the playback was stopped via the network communication portion 51 and stores the received time information of the contents when the playback was stopped in the memory device 62.

In a case where the user makes a playback stop operation on the input switch matrix portion 58 while the contents received from the contents supply portion 12 are being played back by the operation control portion 13, the CPU 59 stores the time information of the contents when the playback was stopped in the memory portion 62.

The operation control portion 13 may include a non-volatile memory, such as an EEPROM. By including a non-volatile memory, even when the power supply is turned off, information stored and held therein will not be lost, which makes it possible to store and hold, for example, various setting parameters.

Besides the contents display and playback program and various processing programs, the ROM 60 pre-records data necessary for the processing. The RAM 60 is chiefly used as a work area for various types of processing and temporarily stores and holds the data obtained as the result of various types of processing.

The LCD 61 displays thereon videos according to the video data on which the video signal processing has been applied by the GDP 55. The memory device 62 is, for example, a semiconductor memory or an HDD and stores the contents and the resume information. Also, the memory device 62 has a playback resume information database in which the resume information is registered.

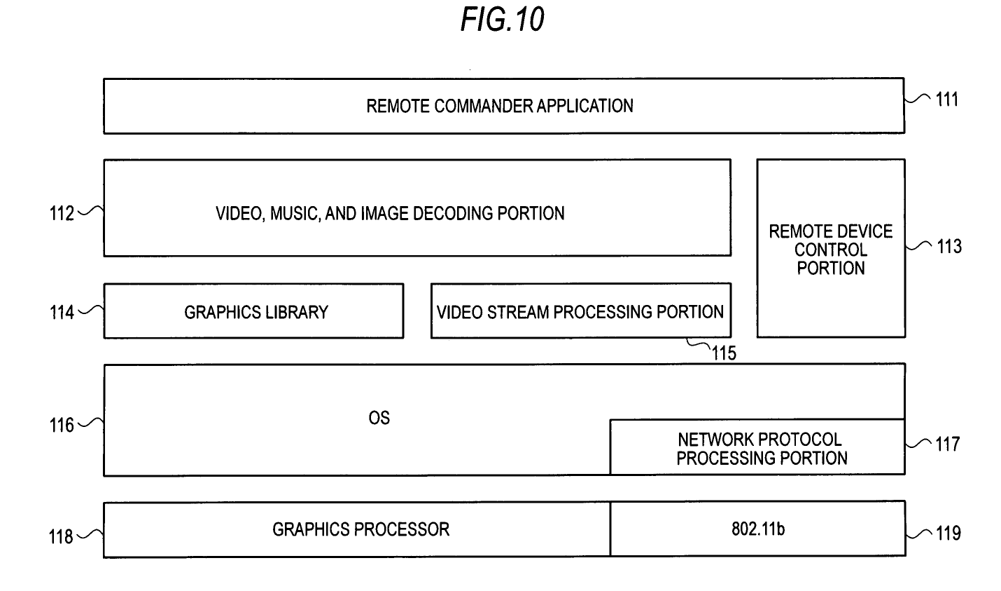

FIG. 10 is a block diagram of software executed by the CPU 59 in the operation control portion 13 having the hardware configuration as described above. There is a remote commander application 111 to control each of the contents supply portion 12 and the display and playback portion 14 by generating a remote control signal. Also, a video, music, and image decoding portion 112, a remote device control portion 113, a graphic library 114, and a video stream processing portion 115 are executed according to an operation system (OS) 116. Also, a network protocol processing portion 117 executes IEEE802.11b wireless protocol 119. The graphic processor 118 is operated by the GDP 55.

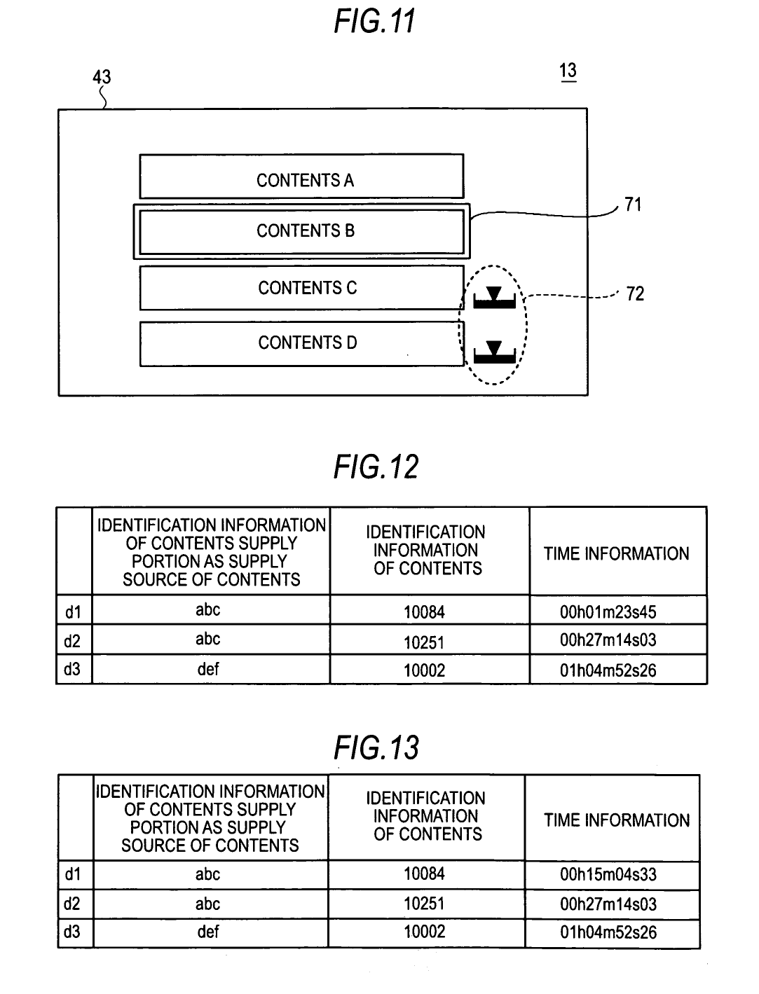

FIG. 11 is an example of the contents list display. As is shown in FIG. 11, “Contents A”, “Contents B”, “Contents C”, and “Contents D”, which are the content titles, are displayed as the contents list on the list display portion 43 in the operation control portion 13.

Of the contents whose titles are displayed in the contents list, for “Contents C” and “Contents D” whose contents have been displayed to some midpoint by the operation control portion 13 or the display and playback portion 14, icons 72 are displayed in the vicinity of the titles on the right side. By contrast, for “Contents A” and “Contents B” whose contents have not been played back to some midpoint by the operation control portion 13 or the display and playback portion 14, no icons 72 are displayed in the vicinity of the titles on the right side. In short, the icons 72 indicate that the playback resume information is stored in the operation control portion 13.

A focus 71 moves up and down as the user operates the input operation acceptance portion 50. The user is thus able to select a desired title among those in the contents list by placing focus thereon.

FIG. 12 shows an example of the playback resume information database. As is shown in FIG. 12, the playback resume information database includes the following items: identification information of the contents supply portions as the supply source of the contents, the identification information of the contents, the time information of the contents when the playback was stopped (hereinafter, occasionally referred to as the contents playback time), and the titles of the contents, and information in one item is correlated with information in another item. In addition, when the necessity arises, the identification information of the display and playback portion 14 that has been playing back the contents of interest before the contents of interest are downloaded into the operation control portion 13 may be further stored in correlation with information in the other items. FIG. 12 shows a case where three pieces of playback resume information d1, d2, and d3 are registered.

The identification information of the contents supply portion 12 is the device identification information that uniquely identifies an individual contents supply portion 12 within the home network 11. The identification information of the contents is the identification information that uniquely identifies individual contents within the net homework 11. The time information when the playback was stopped (the playback time of the contents) is information specifying the playback position of the contents (playback time) when the playback was stopped by the operation control portion 13 while the contents were being played back by the display and playback portion 14 or the operation control portion 13. The identification information of the display and playback portion 14 is device identification information that uniquely identifies an individual display and playback portion 14 within the home network 11.

FIG. 13 shows an example in a case where the playback resume information database shown in FIG. 12 is updated. Herein, of the three pieces of the playback resume information d1, d2, and d3, the playback of the contents corresponding to the playback resume information d1 is resumed and stopped again at some midpoint. The time information of the playback resume information d1 is thus updated. More specifically, the time information of the playback resume information d1 is updated from “00h01m23s45” to “00h15m04s33”.

GUI Display and Processing during Playback from Stopped Position

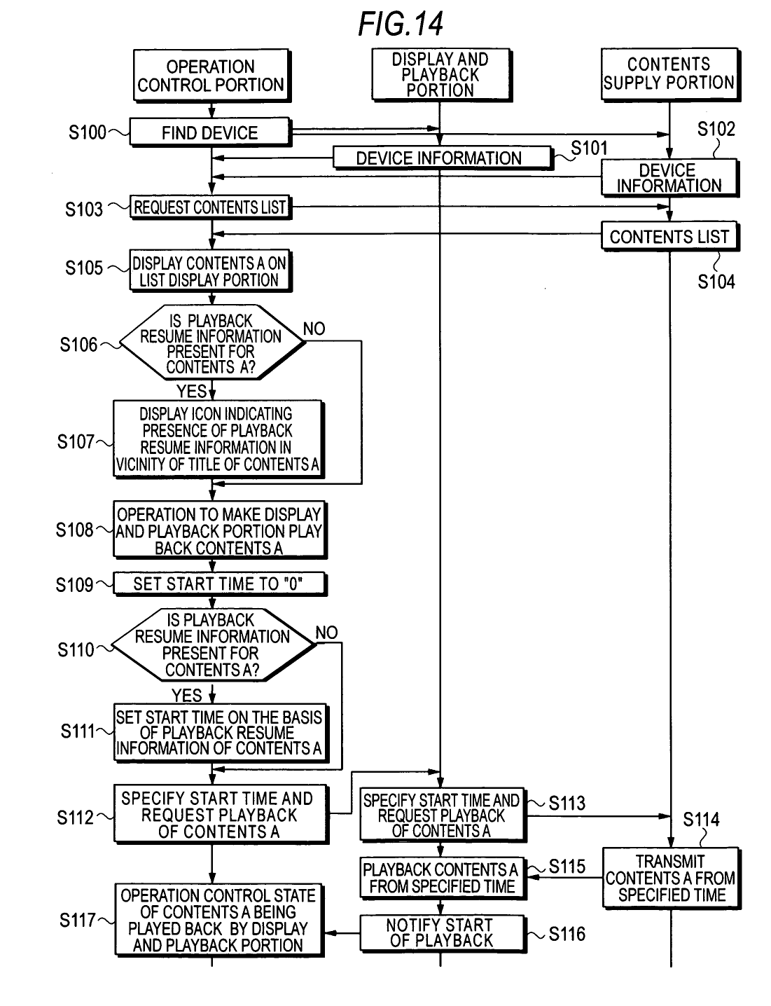

Hereinafter, an example of GUI display and processing during playback from the stopped position using the playback resume information in a case where contents are played back by the display and playback portion 14 under the playback operation control by the operation control portion 13 will be described with reference to FIG. 14.

Before the processing depicted in FIG. 14 is started, the operation control portion 13, the display and playback portion 14, and the contents supply portion 12 are linked to the home network 11. Subsequently, in Step S100, the operation control portion 13 transmits a response request to the contents supply portion 12 and the display and playback portion 14 in order to detect compatible devices within the home network 11. In Step S101, in response to this request, the display and playback portion 14 transmits device identification information that uniquely identifies the self within the home network 11 and device information, such as, the display and playback performance, to the operation control portion 13. Also, in Step S102, the contents supply portion 12 transmits the device identification information that uniquely identifies the self within the hone network 11 and the device information, such as the types of contents it can supply, to the operation control portion 13.

Subsequently, in Step S103, the operation control portion 13 requests a contents list to the contents supply portion 12. In response to this request, the contents supply portion 12 transmits the contents list to the operation control portion 13 in Step S104.

Hereinafter, of a plurality of contents included in the contents list shown in FIG. 11, a case where the contents under the title of “Contents A” (hereinafter, referred to as the contents A) are displayed on the list display portion 43 will be described by way of example. It goes without saying that contents under the titles of “Contents B”, “Contents C”, and so forth other than the contents A can be displayed on the list display portion 43 in the same manner.

In Step S105, the operation control portion 13 first displays the title of the contents A on the list display portion 43. Subsequently, in Step S106, the operation control portion 13 performs processing as follows. The operation control portion 13 checks the playback resume information database in the memory portion 46 according to the identification information of the contents supply portion 12, which is the supply source of the contents A, and the identification of the contents A itself among the pieces of information making up the contents A in the list creation portion 42. The operation control portion 13 then determines whether the corresponding playback resume information is registered in the playback resume information database.

In a case where it is determined in Step S106 that the corresponding playback resume information is registered in the playback resume information database, the operation control portion 13 displays the icon 72 indicating the presence of the playback resume information in the vicinity of the title of the contents A in Step S107. Meanwhile, in a case where it is determined in Step S106 that the corresponding playback resume information is not registered in the playback resume information database, the operation control potion 13 displays no icon 72 indicating the presence of the playback resume information and skips to the processing in Step S108.

To be more concrete, the operation control portion 13 performs the processing as follows in Step S106. That is, the operation control portion 13 checks the playback resume information database in the memory portion 46 according to the identification information of the contents supply portion 12 as the supply source of the contents A, “abc”, and the identification information of the contents A itself, “10084”, among the pieces of information making up the contents A in the list creation portion 42. In a case where the playback resume information shown in FIG. 12 is registered in the playback resume information database, because the corresponding playback resume information is registered in the playback resume information database, the operation control portion 13 proceeds to the processing in Step S107. In Step S107, the operation control portion 13 displays the icon 72 indicating the presence of the playback resume information in the vicinity of the title of the contents A. Meanwhile, in a case where it is found in Step S106 that the identification information of the contents A among the pieces of information making up the contents A in the list creation portion 42 is “10083” and the playback resume information shown in FIG. 12 is registered in the playback resume information database, the operation control portion 13 performs the processing as follows. That is, because the corresponding playback resume information is not registered in the playback resume information database, the operation control portion 13 skips to the processing in Step S108. Accordingly, no icon 72 indicating the presence of the playback resume information is displayed.

Subsequently, in Step S108, when the user makes an operation to play back the contents A by the display and playback portion 14, the operation control portion 13 sets “0”, to be more exact, “00h00m00s00”, to the playback start time in Step S109 as a preparation for a playback instruction.

Subsequently, in Step S110, the operation control portion 13 determines whether the playback resume information of the contents A is registered in the playback resume information database. In a case where it is determined in Step S110 that the playback resume information of the contents A is registered in the playback resume information database, the operation control portion 13 performs the processing as follows in Step S111. That is, the operation control portion 13 sets the time information of the playback resume information of the contents A registered in the playback resume information database to the playback start time. Meanwhile, in a case where it is determined in Step S110 that the playback resume information of the contents A is not registered in the playback resume information database, the operation control portion 13 proceeds to the processing in Step S112 by skipping Step S111.

To be more concrete, for example, the operation control portion 13 performs the processing as follows in Step S110. In a case where the identification information of the contents A is “10084” and the playback resume information shown in FIG. 12 is registered in the playback resume information database, the identification information of the contents A and the time information, “00h01m23s45”, are correlated with each other. Hence, the operation control portion 13 proceeds to the processing in Step S111. In Step S111, the operation control portion 13 sets “00h01m23s45” to the playback start time. Meanwhile, in a case where the identification information of the contents A is “10083”, there is no time information. The operation control portion 13 therefore skips to the processing in Step S112. The start time thus remains at “0”, to be more exact, “00h00m00s00”.

Subsequently, in Step S112, the operation control portion 13 specifies the playback start time set in Step S111 to the display and playback portion 14 and requests the playback of the contents A. Subsequently, in Step S113, upon receipt of the playback request of the contents A from the operation control portion 13, the display and playback portion 14 specifies the start time to the contents supply portion 12, which is the supply source of the contents A, and requests the playback of the contents A.

Subsequently, in Step S114, upon receipt of the playback request of the contents A from the display and playback portion 14, the contents supply portion 12 transmits the contents A to the display and playback portion 14 from the specified time in the contents playback request. Subsequently, in Step S115, the display and playback portion 14 receives the contents A from the contents supply portion 12, and the contents A are played back by the contents display portion 34 and the contents audio output portion 35. Subsequently, in Step S116, the display and playback portion 14 notifies the operation control portion 13 of having become the playback state. Subsequently, in Step S117, upon receipt of the notice from the display and playback portion 14 informing that it has become the playback state, the operation control portion 13 becomes an operation control state of the contents A. Accordingly, the operation control portion 13 becomes able, for example, to fast forward and fast rewind the contents A as well as to pause and stop the playback.

When the titles of the contents are displayed on the list display portion 43 in the processing depicted in FIG. 14, the determinations in Step S106 and Step S110 may be used in common. To be more specific, the determination as to whether the icon 72 indicating the presence of the playback resume information is to be displayed (Step S106) and the determination made to set the start time that is specified when the playback is requested (Step S110) may be used in common.

Processing during Playback Stop Operation

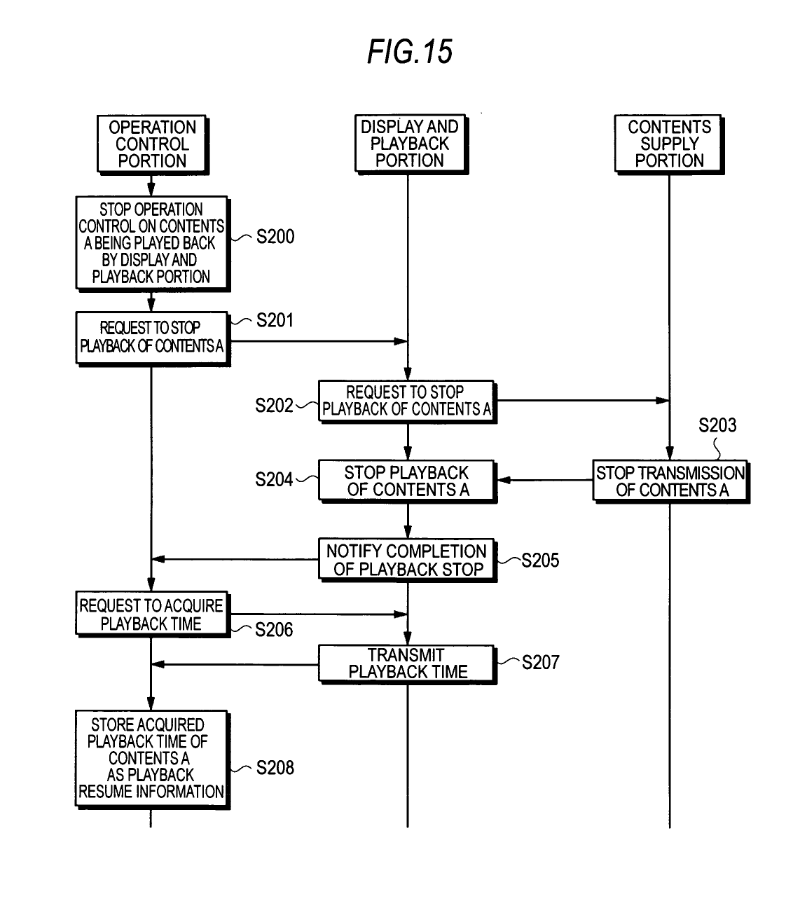

Hereinafter, an example of the processing to store the playback resume information of contents by performing playback stop operation control while the contents are being played back will be described with reference to FIG. 15.

Initially, when stop operation control is performed by the operation control portion 13 while the contents A are being played back by the display and playback portion 14 in Step S200, the operation control 13 transmits a stop request to the display and playback portion 14 in Step S201.

Subsequently, in Step S202, upon receipt of the stop request from the operation control portion 13, the display and playback portion 14 transmits a stop request to the contents supply portion 12. Subsequently, in Step S203, upon receipt of the stop request from the display and playback portion 14, the contents supply portion 12 stops transmitting the contents A to the display and playback portion 14. Consequently, in Step S204, the display and playback portion 14 stops playing back the contents A, and in Step S205, the display and playback portion 14 notifies the operation control portion 13 of the completion of playback stop of the contents A.

Subsequently, in Step S206, upon reception of the notice of the completion of playback stop of the contents A from the display and playback portion 14, the operation control portion 13 transmits an acquisition request of the playback time of the contents A to the display and playback portion 14 in order to acquire the playback time (time information when the playback was stopped) of the contents A. Subsequently, in Step S207, upon receipt of the acquisition request of the playback time of the contents A from the operation control portion 13, the display and playback control portion 14 transmits the playback time to the operation control portion 13.

Subsequently, in Step S208, the operation control portion 13 updates the time information of the playback resume information of the contents A in the playback resume information database according to the playback time of the contents A acquired from the display and playback portion 14.

To be more concrete, in a case where the identification information of the contents supply portion 12 is “abc”, the identification information of the contents A is “10084”, and the playback time of the contents A acquired from the display and control portion 14 is “00h15m04s33”, the operation control portion 13 performs the update processing as follows. That is, it updates the time information of the playback resume information d1, “00h01m23s45”, shown in FIG. 12 to the time information of the playback resume information d1, “00h15m04s33”, shown in FIG. 13.

In a case where it is determined that the playback resume information of the contents A is not registered in the playback resume information database in Step S106 and Step S110, the playback resume information is newly added when the playback of the contents is stopped at some midpoint. To be more concrete, the playback resume information of the contents A is newly added to the playback resume information database. For example, playback resume information d4 is newly added to the playback resume information database shown in FIG. 12.

Processing during Download

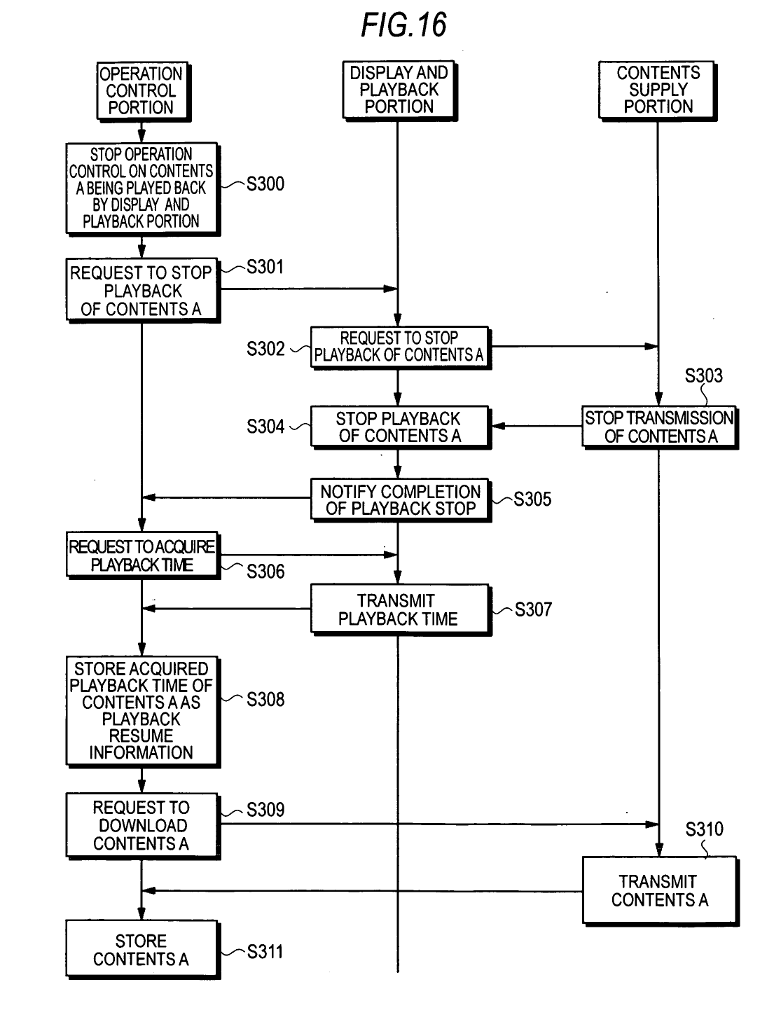

Hereinafter, an example of the processing to download contents from the contents supply portion 12 into the operation control portion 13 will be described with reference to FIG. 16.

Processing in Steps S300 through S308 is the same as the processing in Steps S200 through S208 depicted in FIG. 15.

In Step S309, when a download operation of contents is made by the operation control portion 13, the operation control portion 13 transmits a contents transmission request and the identification information of the contents A to the contents supply portion 12. Subsequently, in Step S310, upon receipt of the contents transmission request and the identification information of the contents A from the operation control portion 13, the contents supply portion 12 retrieves the contents A from the contents accumulation portion 22 according to the identification information of the contents A. The contents supply portion 12 then transmits the contents A thus retrieved to the operation control portion 13. Subsequently, the operation control portion 13 receives the contents A from the contents supply portion 12 and stores the contents A, for example, in correlation with the identification information of the contents supply portion 12, the identification information of the contents A, and the playback time of the contents A. It should be noted that the playback time of the contents A is the time information acquired from the display and playback portion 14 in Step S308. In short, it is the playback time of the contents A when the playback stop operation was made in Step S300.

The contents A downloaded as has been described are played back by the operation control portion 13, for example, in the following manner. The operation control portion 13 first displays the list of the titles of contents stored in the memory portion 46 in response to an operation on the input operation acceptance portion 50. When the title (hereinafter, referred to as the title A) of the contents A the user wishes be played back is selected from the list by an operation on the input operation acceptance portion 50, the operation control portion 13 retrieves the playback time of the contents A correlated with the title A from the memory portion 46, and plays back the contents A stored in the memory portion 46 according to the retrieved playback time of the contents A. Accordingly, the contents A are played back by the operation control portion 13 continuously from the point up to which the contents A have been played back by the display and playback portion 14.

Processing during Seamless Playback

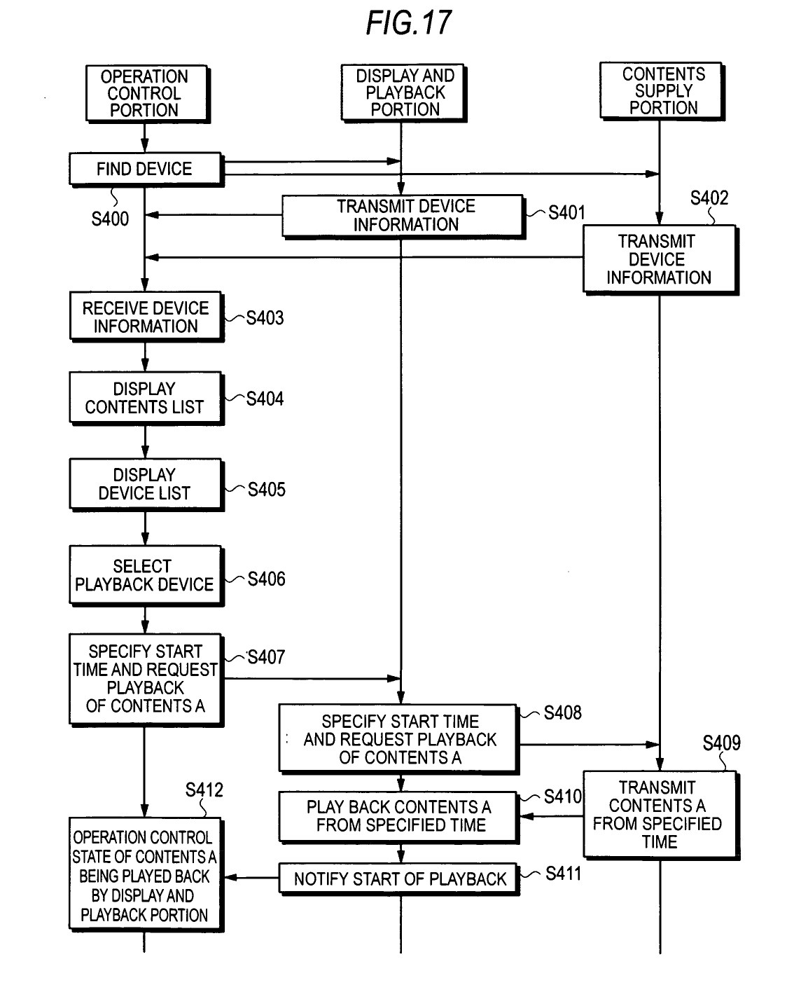

Hereinafter, an example of the processing to play back contents that have been played back to some midpoint by the operation control portion 13 seamlessly by the display and playback portion 14 will now be described with reference to FIG. 17.

Initially, before the processing depicted in FIG. 17 is started, the operation control portion 13, the display and playback portion 14, and the contents supply portion 12 are linked to the home network 11. Subsequently, in Step S400, the operation control portion 13 transmits a response request to the contents supply portion 12 and the display and playback portion 14 in order to detect compatible devices within the home network 11. In Step S401, in response to this request, the display and playback portion 14 transmits the device identification information that uniquely identifies the self within the home network 11 and device information, such as the display and playback performance, to the operation control portion 13. Also, in Step S402, the contents supply portion 12 transmits the device identification information that uniquely identifies the self within the home network 11 and device information, such as the types of contents it can supply, to the operation control portion 13.

Subsequently, in Step S403, upon reception of the device identification information and the device information from the contents supply portion 12 and the display and playback portion 14, the operation control portion 13 stores the received information in the memory portion 46. Subsequently, in Step S404, the operation control portion 13 displays a list of the titles of contents stored in the memory portion 46 of the operation control portion 13 in response to an operation on the input manipulation acceptance portion 50. Subsequently, in Step S405, when the desired title A is selected from the contents list through the input operation acceptance portion 50, the operation control portion 13 searches for a display and playback portion 14 capable of playing back the contents under the title A. To be more concrete, the operation control portion 13 searches for a display and playback portion 14 capable of playing back the contents A selected in Step S404 according to the device identification information and the device information stored in the memory portion 46 and displays the search result in the form of a list. Subsequently, in Step S406, when the desired display and playback portion 14 is selected from the device list through the input operation acceptance portion 50, the operation control portion 13 proceeds to the processing in Step S407. In Step S407, the operation control portion 13 specifies the playback start time to the display and playback portion 14 selected in Step S406 and requests the playback of the contents A to the display and playback portion 14. To be more concrete, the operation control portion 13 retrieves from the memory portion 46 the identification information of the contents supply portion 12, the identification information of the contents A, and the playback time of the contents A, all of which are correlated with the title A selected in Step S405. The operation control portion 13 then transmits the retrieved pieces of information to the display and display portion 14 selected in Step S406.

Subsequently, in Step S408, the display and playback portion 14 receives the identification information of the contents supply portion 12, the identification information of the contents A, the time information of the contents A from the operation control portion 13. The display and playback portion 14 then transmits the identification information of the contents A and the playback time of the contents A thus received to the contents supply portion 12 corresponding to the received identification information of the contents supply portion 12 and requests the playback of the contents A. In Step S409, the contents supply portion 12 retrieves the contents A from the contents accumulation portion 22 according to the identification information of the contents A received from the display and playback portion 14. The contents supply portion 12 supplies the retrieved contents A to the display and playback portion 14 from the time according to the playback time of the contents A received from the display reproduction portion 14.

Subsequently, in Step S410, the display and playback portion 14 receives the contents A from the contents supply portion 12 and plays back the received contents A using the contents display portion 34 and the contents audio output portion 35. Subsequently, in Step S411, the display and playback portion 14 notifies the operation control portion 13 of having become a playback state. Subsequently, in Step S412, upon receipt of the notice from the display and playback portion 14 informing that it has become the playback state, the operation control portion 13 becomes an operation control state of the contents A. Consequently, the operation control portion 13 becomes able, for example, to fast forward and fast rewind the contents A as well as to pause and stop the playback.

According to an embodiment of the present invention, even when the user stops the playback because of his convenience at some midpoint while streaming playback is being performed by the display and playback portion 14 or the operation control portion 13 itself, it is possible to resume the playback of the contents from the stopped position.

When the contents list of the contents supply portion 12 is displayed on the operation control portion 13, contents for which the playback resume information is stored in the operation control portion 13 and contents for which the playback resume information is not stored are displayed on the list display portion 43 in different manners. Hence, the user becomes able to understand at a glance whether the contents specified to be played back will be played back not from the beginning but from the stopped position.

In addition, when the playback resume information is saved in the memory portion 46 in the operation control portion 13, the identification information of the contents and the identification information of the contents supply portion 12, which is the supply source of the contents, are saved in the memory portion 46 in correlation with each other. This configuration makes it possible to check the absence or presence of the playback resume information for the contents of interest even when more than one contents supply portion 12 is linked to the home network 11.

Also, it is possible to save the playback resume information not only for the latest contents that have been played back and stopped at some midpoint but also for a plurality of contents in the operation control portion 13. This capability eliminates an unfavorable situation that even when the user stopped the playback at some midpoint wishing to resume the playback later from the stopped position, he has to view or listen to the contents from the beginning.

In a case where more than one user has his own operation control portion 13, by storing the playback resume information in the memory portion 46 in each operation control portion 13, it becomes possible to save the playback resume information of the same contents for each user. Hence, even where there is more than one user of the contents display and playback system 1, each user is able to resume the playback of the contents from the position he has stopped last time. On the contrary, in a case where the playback resume information is stored in the contents supply portion 12, the contents and the playback resume information are in a one-to-one correspondence. It is therefore difficult for each user to resume the playback of the contents from the point he has stopped last time in a case where there is more than one user for the contents and display system 1.

In a case where contents are shared between the contents supply portion (for example, stationary devices, such as an HDD recorder or an HDD component set) 12 on the home network 11 and the operation control portion (portable device, such as Walkman®) 13, it is preferable to perform the processing as follows. That is, in addition to an exchange of authorizations, such as check-in and check-out as before, it is preferable to perform takeover of the playback position information of contents. By performing such processing, the user is enabled to enjoy the contents continuously among different devices. To be more concrete, for example, the user having enjoyed the contents played back to some midpoint by the portable device outside the home is able to continuously enjoy the contents by the home AV device or the stationary device on the home network 11. The user can enjoy contents in an inverse manner, too. As has been described, the processing to enable the contents the user has been reviewing using the portable device to be played back continuously by the home AV device is particularly effective in a case where the user wishes to view a long-hour drama.

In addition, the user is able to enjoy the contents seamlessly without any troublesome operation between the operation control portion 13, such as a portable device, and the display and playback portion 14, such as an AV device on the home network 11.

### (2) Second Embodiment

Hereinafter, descriptions will be given by labeling portions corresponding to those in the first embodiment above with the same reference numerals. In a second embodiment, the contents supply portion 12 is different from the counterpart in the first embodiment above in that it has the DMR capability, that is, the capability of the display and playback portion 14.

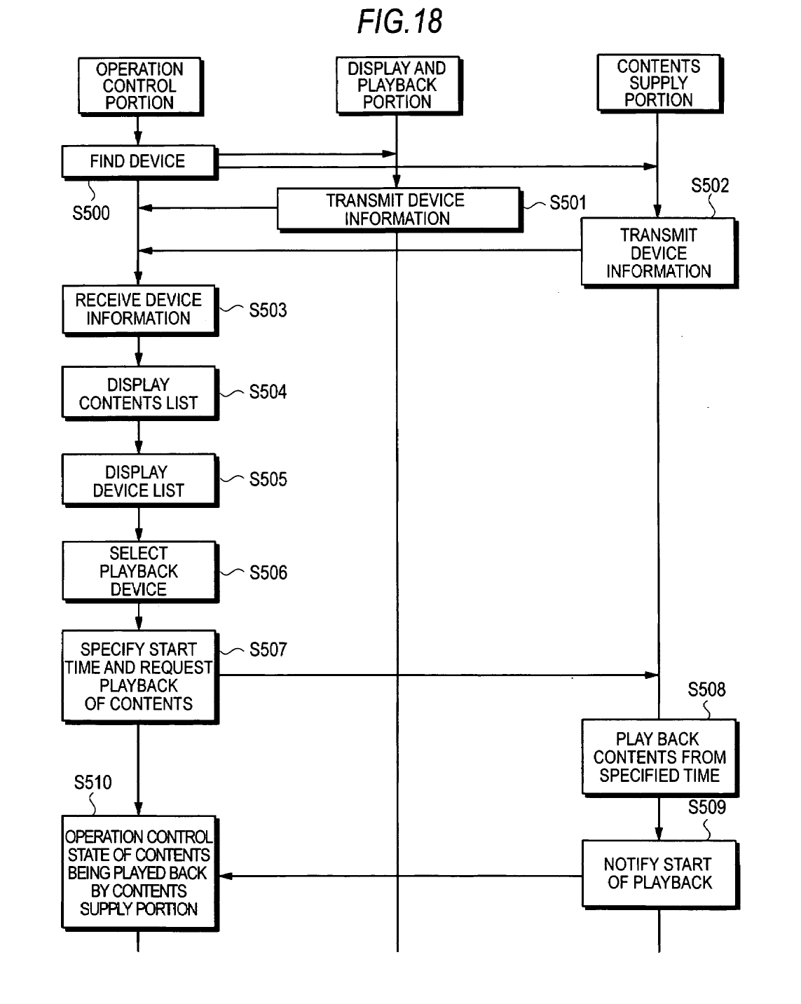

Hereinafter, an example of operations when the contents that have been played back by the operation control portion 13 to some midpoint are played back seamlessly by the display and playback portion 14 will be described with reference to FIG. 18.

Processing in Steps S500 through S504 is the same as the processing in Steps S400 through S404 depicted in FIG. 17.

When the desired title A is selected from the contents list through the input operation acceptance portion 50 in Step S505, the operation control portion 13 searches for a display and playback portion 14 and a contents supply portion 12 capable of playing back the contents under the title A. To be more concrete, the operation control portion 13 searches for the display and playback portion 14 and the contents supply portion 12 capable of playing back the contents A selected in Step S504 according to the device identification information and the device information stored in the memory portion 46 and displays the search result in the form of a list. Subsequently, in Step S506, when the desired contents supply portion 12 is selected from the device list through the input operation acceptance portion 50, the operation control portion 13 proceeds to the processing in Step S507. In Step S507, the operation control portion 13 specifies the playback start time to the contents supply portion 12 selected in Step S506 and requests the playback of the contents A to the contents supply portion 12. To be more concrete, the operation control portion 13 retrieves the identification information of the contents A and the playback time of the contents A both correlated with the title A selected in Step S505 from the memory portion 46. The operation control portion 13 then transmits these retrieved pieces of information to the contents supply portion 12 selected in Step S506.

Subsequently, in Step S508, the contents supply portion 12 receives the identification information of the contents A and the playback time of the contents A from the operation control portion 13. The contents supply portion 12 then retrieves the contents A from the contents accumulation portion 22 according to the identification information of the contents A received from the operation control portion 13 and plays back the retrieved contents A from the time according to the playback time of the contents A received from the display and playback portion 14.

Subsequently, in Step S509, the contents supply portion 12 notifies the operation control portion 13 of having become a playback state. Subsequently, in Step S510, upon receipt of the notice from the contents supply portion 12 informing that it has become the playback state, the operation control portion 13 becomes an operation control state of the contents A. Consequently, the operation control portion 13 becomes able, for example, to fast forward and fast rewind the contents A as well as to pause and stop the playback.

While embodiments of the present invention have been described concretely, it should be appreciated that the present invention is not limited to the embodiments above and the present invention can be modified in various manners in light of the technical ideas of the present invention.

For example, the configurations and numerical values specified in the embodiments above are mere examples and configurations and numerical values different from the foregoing may be used as the necessity rises.

In the embodiments above, it is preferable that a portable terminal is used as the operation control portion 13 and that in a case where it is difficult to sufficiently increase a capacity of the memory portion 46, the upper limit is set to the number of pieces of the playback resume information in the playback resume information database in the memory portion 46. In a case where the number of pieces of information exceeds the upper limit value, it may be configured in such a manner that the playback resume information is updated by overwriting the newest on the oldest.

The embodiments above described a case where the icon is displayed in the vicinity of the title of the contents by way of example. It is, however, sufficient to display contents for which the playback resume information is present in the operation control portion 13 and contents for which the playback resume information is absent in the operation control portion 13 in different manners, and the present invention is not limited to the case described above. For example, contents with the playback resume information and contents without the playback resume information may be displayed in different manners by showing the titles of the contents in color or in black.

Also, the embodiments above described a case where the AV data is played back by way of example. However, audio data may be played back as well.

Also, the embodiments above described a case where the playback device is the display and playback portion 14 capable of playing back AV data and/or audio data by way of example. It should be appreciated, however, that the playback portion is not limited to the case described above. For example, the playback device may be an audio playback portion capable of playing back audio data.

In the embodiments above, the number of download times of the contents from the contents supply portion 12 into the operation control portion 13 may be limited. For example, the contents supply portion 12 may include a counter that initially indicates the upper limit value (for example, ten) of the number of download times of the contents allowed for the operation control portion 13. The contents supply portion 12 then decrements the counter each time the contents are downloaded, so that the contents supply portion 12 erases the contents when the counter value reaches “0”. Alternatively, the contents supply portion 12 may inhibit the download of contents into the operation control portion 13.

Also, in the embodiments above, DRM contents may be used as contents. In this case, in a case where the contents that have been played back by the operation control portion 13 to some midpoint are played back seamlessly by the display and playback portion 14, for example, the processing as follows is performed. That is, the operation control portion 13 specifies the identification information of the contents to the contents supply portion 12 and uploads the right of the contents. In this instance, the contents may be actually uploaded. However, the processing to actually upload the contents is not necessarily performed and it may be sufficient to upload the contents virtually. Playback of the contents whose right has been uploaded is thus allowed on the home network 11. When the right of the contents is uploaded successfully, playback of the contents by the operation control portion 13 is inhibited. Various authorization schemes are adoptable for authorization of the operation control portion 13, such as a portable device. For example, the operation control portion 13 may be pre-registered in the contents supply portion 12, so that the operation control portion 13 is authorized on the basis of the registered information.

As has been described, the right can be exchanged semi-automatically between the operation control portion 13, such as a portable device, and the contents supply portion 12, which is an AV device on the network 11, even for the DRM contents. Convenience of the user can be thus enhanced markedly in comparison with the existing system.

The first embodiment above described a case where the device list is displayed for the user to select a display and playback portion 14 by which he wishes the contents be played back (see FIG. 17). It should be appreciated, however, that the present invention is not limited to this case. For example, it may be configured in such a manner that when the user selects the contents that have been played back to some midpoint by the operation control portion 13 to resume the playback, the playback is automatically resumed by the playback device used immediately before the contents are downloaded into the operation control portion 13.

To be more concrete, it may be configured as follows. That is, when the contents A are downloaded, the identification information of the display and playback portion that was playing back the contents A immediately before the contents A are downloaded is stored in the memory portion 46 in correlation with the identification information of the contents supply portion, the identification information of the contents A, and the playback time of the contents A. In a case where after the user played back the contents A downloaded into the display control portion 13, he makes an operation to resume the playback the rest on the home network 11, the contents A are played back as follows. That is, the operation control portion 13 retrieves the identification information of the display and playback portion and the identification information of the contents supply portion both correlated with the contents A requested to be played back, as well as the identification information of the contents A and the playback time of the contents A from the memory portion 46. It then transmits the identification information of the contents supply portion, the identification information of the contents A, and the playback time of the contents A to the display and playback portion 14 corresponding to the identification information of the display and playback portion.

The second embodiment above described a case where the device list is displayed for the user to select a desired contents supply portion 12 by which he wishes the contents be played back (see FIG. 18). It should be appreciated, however, that the present invention is not limited to this case. For example, it may be configured in such a manner that when the user selects the contents that have been played back to some midpoint by the operation control portion 13 to resume the playback, the playback is automatically resumed by the contents supply portion 12 used immediately before the contents are downloaded into the operation control portion 13.

To be more concrete, it may be configured as follows. That is, when the contents A are downloaded, the identification information of the contents supply portion 12 that has been playing back the contents A immediately before the contents A are downloaded is stored in the memory portion 46 in correlation with the identification information of the contents A and the playback time of the contents A. In a case where after the user played back the contents A downloaded into the display control portion 13, he makes an operation to resume the playback the rest on the home network 11, the contents A are played back as follows. That is, the operation control portion 13 retrieves the identification information of the contents supply portion 12 correlated with the contents A requested to be played back, the identification information of the contents A, and the playback time of the contents A from the memory portion 46. It then transmits the identification information of the contents A and the playback time of the contents A to the contents supply portion 12 corresponding to the identification information of the contents supply portion 12.

The present application contains subject matter related to that disclosed in Japanese Priority Patent Application JP 2008-162320 and JP 2009-072342 filed in the Japan Patent Office on Jun. 20, 2008 and Mar. 24, 2009, respectively, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An operation control apparatus comprising:
a display portion that displays information thereon;
a communication portion that communicates with a contents supply device and a playback device via a network;
an operation portion that operates the contents supply device and the playback device via the communication portion;
a memory portion that stores therein identification information of contents received from the contents supply device when a playback stop operation is made by the operation portion while the contents are being played back; and
a control portion that displays a contents list on the display portion according to contents information received from the contents supply device;
wherein the control portion checks identification information of contents contained in the contents information received from the contents supply device against the identification information of the contents stored in the memory portion when the contents list is displayed on the display portion and displays a title of contents having a match and a title of contents having no match in different manners.

2. The operation control apparatus according to claim 1,
wherein the control portion displays a mark indicating that contents have been played back to some midpoint in a vicinity of the title of the contents having a match.

3. The operation control apparatus according to claim 1,
wherein the memory portion stores therein playback position information of the contents when playback was stopped and the identification information of the contents in correlation with each other when the playback stop operation is made by the operation portion while the contents received from the contents supply device are being played back.

4. The operation control apparatus according to claim 3,
wherein, when a playback operation is made by the operation portion, the control portion checks identification information of contents selected by the playback operation against the identification information of the contents stored in the memory portion and when there is a match, plays back the contents according to the playback position information correlated with the identification information of the contents having a match.

5. The operation control apparatus according to claim 1,
wherein, when the playback stop operation is made by the operation portion while the contents received from the contents supply device are being played back, the memory portion stores therein playback position information of the contents when playback was stopped, the identification information of the contents, and identification information of the contents supply device that has transmitted the contents.

6. The operation control apparatus according to claim 5,
wherein, when a playback operation is made by the operation portion, the control portion checks identification information of contents selected by the playback operation against the identification information of the contents stored in the memory portion, and when there is a match, transmits the identification information of the contents having a match, as well as the playback position information and the identification information of the contents supply device both correlated with the identification information of the contents to the playback device.

7. The operation control apparatus according to claim 1,
wherein, when the playback stop operation is made by the operation portion while the contents received from the contents supply device are being played back by the playback device, the control portion stores the identification information of the contents in the memory portion.

8. The operation control apparatus according to claim 1,
wherein the control portion displays the contents received from the contents supply device on the display portion.

9. The operation control apparatus according to claim 1,
wherein the memory portion overwrites newest identification information of contents on oldest identification information of contents in a case where the number of pieces of identification information of contents stored in the memory portion exceeds a predetermined number.

10. The operation control apparatus according to claim 1,
wherein, in a case where the playback stop operation is made by the operation portion while the contents received from the contents supply device are being played back by the playback device and an acquisition operation is subsequently made by the operation portion for the contents to which the playback stop operation was made, the control portion acquires the contents selected by the acquisition operation from the contents supply device and acquires playback position information of the contents selected by the acquisition operation from the playback device to store the acquired contents in the memory portion in correlation with the identification information of the contents, the playback position information of the contents, and the identification information of the contents supply device from which the contents was acquired.

11. The operation control apparatus according to claim 10,
wherein, when a playback operation of the contents acquired from the contents supply device is made by the operation portion, the control portion retrieves from the memory portion the identification information of the contents and the playback position information of the contents correlated with the contents and plays back the contents stored in the memory portion according to the retrieved information.

12. The operation control apparatus according to claim 10,
wherein, when an operation to playback contents by the playback device is made, the control portion retrieves from the memory portion the identification information of the contents selected by the operation to play back the contents, the playback position information of the contents, and the identification information of the contents supply device from which the contents was acquired, and transmits the retrieved information to the playback device.

13. A method of displaying a contents list comprising the steps of:
storing identification information of contents received from a contents supply device via a network in a memory portion when a playback stop operation is made by an operation portion while the contents are being played back; and
checking identification information of contents contained in contents information received from the contents supply device against the identification information of the contents stored in the memory portion and displaying a title of contents having a match and a title of contents having no a match in different manners.

14. A contents display and playback system comprising:
a contents supply device that accumulates contents therein;
a playback device that plays back contents received from the contents supply device via a network; and
an operation control apparatus that operates the contents supply device and the playback device via the network;
wherein the operation control apparatus includes,
a display portion that displays information thereon,
a communication portion that communicates with the contents supply device and the playback device via the network,
an operation portion that operates the contents supply device and the playback device via the communication portion,
a memory portion that stores therein identification information of the contents received from the contents supply device when a playback stop operation is made by the operation portion while the contents are being played back, and
a control portion that displays a contents list on the display portion according to the contents information received from the contents supply device, and
the control portion checks identification information of contents contained in the contents information received from the contents supply device against the identification information of the contents stored in the memory portion when the contents list is displayed on the display portion, and displays a title of contents having a match and a title of contents having no match in different manners.
